(19) United States
(12) Patent Application Publication
(10) Pub. No.: US 2001/0011228 A1
(43) Pub. Date: Aug. 2, 2001

(54) METHOD FOR PREDICTIVE ROUTING OF INCOMING CALLS WITHIN A COMMUNICATION CENTER ACCORDING TO HISTORY AND MAXIMUM PROFIT/CONTRIBUTION ANALYSIS

(76) Inventor: GRIGORY SHENKMAN, SOUTH SAN FRANCISCO, CA (US)

Correspondence Address: CENTRAL COAST PATENT AGENCY, PO BOX 187, AROMAS, CA, 95004, US

(21) Appl. No.: 09/127,284

(22) Filed: Jul. 31, 1998

(51) Int. Cl. G06F 17/60

(52) U.S. Cl. 705/14; 705/7

(57) ABSTRACT

A method for routing transaction requests in a hosted communication network comprises steps for preparing a customer data repository including specific customer data and customer transaction history, receiving a new transaction request, identifying the initiator of the transaction request, consulting the customer data repository and determining potential profitability of a new transaction based on the transaction request according to the repository information, and routing the transaction request to an available resource based on the identified potential profitability. To accomplish the method a router accesses categorized information concerning customer demographics, transaction histories, product preferences and the like, and applies formulas developed to determine a profit potential for each incoming transaction request. In some embodiments product promotions are included in the process.

### FIELD OF THE INVENTION

The present invention is in the field of telecommunications including data-network-telephony (DNT) which encompasses Internet-protocol-network-telephony (IPNT), and pertains more particularly to methods and apparatus for predictively routing calls within a communication center according to known customer history and performed profit/contribution analysis.

### BACKGROUND OF THE INVENTION

In the field of telephony communication, there have been many improvements in technology over the years that have contributed to more efficient use of telephone communication within hosted call-center environments. Most of these improvements involve integrating the telephones and switching systems in such call centers with computer hardware and software adapted for, among other things, better routing of telephone calls, faster delivery of telephone calls and associated information, and improved service with regard to client satisfaction. Such computer-enhanced telephony is known in the art as computer-telephony integration (CTI).

Generally speaking, CTI systems of various design and purpose are implemented both within individual call-centers and, in some cases, at the telephone network level. For example, processors running CTI software applications may be linked to telephone switches, service control points (SCP), and network entry points within a public or private telephone network. At the call-center level, CTI-enhanced processors, data servers, transaction servers, and the like, are linked to telephone switches and, in some cases, to similar CTI hardware at the network level, often by a dedicated digital link. CTI and other hardware within a call-center is commonly referred to as customer premises equipment (CPE). It is the CTI processor and application software is such centers that provides computer enhancement to a call center.

In a CTI-enhanced call center, telephones at agent stations are connected to a central telephony switching apparatus, such as an automatic call distributor (ACD) switch or a private branch exchange (PBX). The agent stations may also be equipped with computer terminals such as personal computers with video display unit's (PC/VDU's) so that agents manning such stations may have access to stored data as well as being linked to incoming callers by telephone equipment. Such stations may be interconnected through the PC/VDUs by a local area network (LAN). One or more data or transaction servers may also be connected to the LAN that interconnects agent stations. The LAN is, in turn, connected to the CTI processor, which is connected to the call switching apparatus of the call center.

When a call arrives at a call center, whether or not the call has been pre-processed at an SCP, typically at least the telephone number of the calling line is made available to the receiving switch at the call center by the network provider. This service is available by most networks as caller-ID information in one of several formats. If the call center is computer-enhanced (CTI) the phone number of the calling party may be used as a key to access additional information from a customer information system (CIS) database at a server on the network that connects the agent workstations. In this manner information pertinent to a call may be provided to an agent as a screen pop on the PC/VDU.

In recent years, advances in computer technology, telephony equipment, and infrastructure have provided many opportunities for improving telephone service in publicly-switched and private telephone intelligent networks. Similarly, development of a separate information and data network known as the Internet, together with advances in computer hardware and software have led to a new multimedia telephone system known in the art by several names. In this new systemology, telephone calls are simulated by multimedia computer equipment, and data, such as audio data, is transmitted over data networks as data packets. In this application the broad term used to describe such computer-simulated telephony is Data Network Telephony (DTN).

For purposes of nomenclature and definition, the inventors wish to distinguish clearly between what might be called conventional telephony, which is the telephone service enjoyed by nearly all citizens through local telephone companies and several long-distance telephone network providers, and what has been described herein as computer-simulated telephony or data-network telephony. The conventional system is familiar to nearly all, and is often referred to in the art as Connection-Orientated-Switched-Telephony (COST). The COST designation will be used extensively herein. The computer-simulated, or DNT systems are familiar to those who use and understand computer systems. Perhaps the best example of DNT is telephone service provided over the Internet, which will be referred to herein as Internet-Protocol-Network-Telephony (IPNT), by far the most extensive, but still a subset of DNT.

Both systems use signals transmitted over network links. In fact, connection to data networks for DNT such as IPNT is typically accomplished over local telephone lines, used to reach such as an Internet Service Provider (ISP). The definitive difference is that COST telephony may be considered to be connection-oriented telephony. In the COST system, calls are placed and connected by a specific dedicated path, and the connection path is maintained over the time of the call. Bandwidth is thus assured. Other calls and data do not share a connected channel path in a COST system. In a DNT system, on the other hand, the system is not dedicated or connection oriented. That is, data, including audio data, is prepared, sent, and received as data packets. The data packets share network links, and may travel by varied and variable paths. There is thus no dedicated bandwidth.

Recent improvements to available technologies associated with the transmission and reception of data packets during real-time DNT communication have enabled companies to successfully add DNT, principally IPNT, capabilities to existing CTI call centers. In typical call centers, DNT is accomplished by Internet connection and IPNT calls. For this reason, IPNT and the Internet will be used almost exclusively in examples to follow. IT should be understood, however, that this usage is exemplary, and not limiting.

In systems known to the inventors, incoming IPNT calls are processed and routed within an IPNT-capable call-center in much the same way as COST calls are routed in a CTI-enhanced center, using similar or identical routing rules, waiting queues, and so on, aside from the fact that there are two separate networks involved. Call centers having both CTI and IPNT capability utilize LAN-connected agent-stations with each station having a telephony-switch-connected headset or phone, and a PC connected, in most cases via LAN, to the network carrying the IPNT calls. Therefore, in most cases, IPNT calls are routed to the agent's PC while conventional telephony calls are routed to the agent's conventional telephone or headset. Typically separate lines and equipment must be implemented for each type of call weather COST or IPNT.

Routing of incoming telephony calls within a CTI/DNT call center, or more appropriately termed “communication center” because of inherent multimedia capability, may adhere to many different rules imposed by the company hosting the center. This is especially true for a communication center wherein both CTI and DNT capability is maintained. Routing rules then, may be quite complex. For example, statistical-based and skill-based routing conventions (known to the inventor) are now possible and are implemented in some current art communication centers. Predictive, priority, and real-time availability routing conventions (known to the inventor) may also be practiced.

More traditionally, routing within multimedia communication-centers is based upon one, several or a combination of the above-mentioned rules. The basic focus has centered around matching the right agent to the customer making the call or transaction request. For example, if the customer speaks Spanish and is interested in obtaining information about a certain type of computer, then a Spanish speaking agent specializing in that type of computer is desired to deal with the customer.

History-based predictive routing ( known to the inventor) has been implemented in some communication centers with measured success. In a history-based routing system, customer information along with past history regarding purchases, credit, preferences, satisfaction level at last contact, and the like are used to predict the type of product or service for the customer and the agent that will be best able to service that customer. For example, it may be known through past purchase history that a certain customer buys a computer every two years on the average. His credit is still good with the company and he prefers a Pentium based on past purchase activity. It has been 22 months since his last purchase, and he was discontented somewhat during the last contact which was a service call shortly after that last purchase. Using this information, the system predicts that an agent specializing in servicing and selling Pentiums, with considerable conflict resolution skill would best handle that call. The customer may be queued for that agent even if an agent of different skill set is available.

The above-mentioned example reflects just one of many possible situations wherein what is already known about a customer may aid in routing his or her transaction request. Customer satisfaction is the goal in this instance with the possibility that he will buy another Pentium, of course, taken into account. This system works well in sales/service oriented situations wherein providing good service promotes future business activity. Computer sales, Appliance sales, Catalog-order sales, etc. make up this category. Service is expected from these types of companies, and is often provided equally well to frequent or high-dollar customers and to infrequent or low-dollar customers. In many cases money, which equates to profit margin, is lost because servicing a discontented customer can, depending on circumstance, cost as much or more than the amount spent by that customer patronizing the business.

Many types of organizations are much more profit-oriented than traditional sales/service organizations. Investment companies, Loan companies, Collection agencies, among others, fit into this category. It is desired by owners and administrators of such companies that a high profit margin be maintained as an utmost priority. Such bottom-line profit capability may, in many cases, determine the immediate success or failure of such a company.

What is clearly needed is a method for predictive routing of incoming transaction requests within a communication center based on known historical data wherein a profit-contribution analysis concerning the ongoing customer/business relationship can be determined and used in routing.

### SUMMARY OF THE INVENTION

In a preferred embodiment of the present invention a method for routing transactions in a hosted communication network is provided, comprising steps of (a) preparing a customer data repository including specific customer data and customer transaction history; (b) receiving a new transaction request; (c) identifying the initiator of the transaction request; (d) consulting the customer data repository and determining potential profitability of a new transaction based on the transaction request according to the repository information; and (e) routing the transaction request to an available resource based on the identified potential profitability. In a preferred embodiment as well, the hosted communication network is a telecommunication call center.

One of the data categories used in the method is a classification of customers/clients based at least in part on demographics. Also in some embodiments the data repository tracks customer transaction history at least in part on product choices, and the method further comprises a step for matching a customer's product choices with active product promotions from a product database, and using the result as at least a partial basis for routing. The data retrieved may also be used in selecting scripting for directing an agent in interaction with the customer. After a routing decision there may be a constraints check, and overriding routing if suggested by the constraints check. The constraints check may include one or more of cost, service level, or regulatory requirements.

If a customer is not found the data repository, there may be a further step for routing the transaction request to a resource adapted to solicit information from the customer for adding the customer to the data repository.

In another aspect an intelligent router in a telecommunications network for determining routing to available resources of an incoming transaction request from a customer is provided, comprising an identifier adapted to determine the identity of the customer; a data collector for consulting a data repository including customer transaction histories and retrieving information about the identified customer; a determinator for assessing potential profitability of a transaction based on the transaction request; and a routing selector for selecting a resource for routing the transaction request based on the assessed potential profitability.

The data repository may include a category for the identified customer based at least in part on demographics, and the category is used as at least a partial criteria in routing. The data repository may track customer transaction history based at least in part on product choices, wherein the determinator matches a customer's recorded product choices with active product promotions from a product database, and the routing selector uses the result as at least a partial basis for routing.

After routing product information may be used in selecting scripting for directing an agent in interaction with the customer. Also there may be a constraints check after determining potential profitability, and this may override routing if suggested by the constraints check. The constraints check may include one or more of cost, service level, or regulatory requirements. Further, if the customer identified is not found in the data repository, the transaction request may be routed to a resource adapted to solicit information from the customer for adding the customer to the data repository.

In still another aspect multimedia transaction center is provided, comprising switching and routing apparatus for receiving and distributing transaction requests to available resources; a data repository storing customer data including at least demographics and transaction history; and an intelligent router for determining best routing for incoming transaction requests. The intelligent router identifies initiators of incoming transaction requests, consults the data repository, determines potential profitability of transactions based on the transaction requests, and routes the transaction requests to available resources based on the determination of potential profitability.

In this aspect, in the data repository customers are assigned a category based at least in part on demographics, and the intelligent router uses the category at least in part for determining routing of the incoming transaction requests. The data repository may track customer transaction history at least in part on product choices, and the intelligent router may uses the history of product choices at least a partial basis for routing. After routing, the product information may be used in selecting scripting for directing an agent in interaction with the customer.

Also after routing the intelligent router may make a constraints check after determining potential profitability, and may override routing if suggested by the constraints check. The constraints check may include one or more of cost, service level, or regulatory requirements. If the customer identified is not found in the data repository, the transaction request may be routed to a resource adapted to solicit information from the customer for adding the customer to the data repository.

The apparatus and method of the present invention for the first time provides a system wherein business may be ordered in real time by potential profitability in a way that may be enhanced and updated according to new and better information and procedures.

### BRIEF DESCRIPTION OF THE DRAWING FIGURES

FIG. 1 is a system diagram of a telecommunication network and multimedia communication center according to art known to the inventor but not necessarily public.

FIG. 2 is a system diagram of the telecommunication network and multimedia communication center of FIG. 1 enhanced with predictive history-based routing according to an embodiment of the present invention.

FIG. 3 is a process flowchart illustrating various process steps according to an embodiment of the present invention.

### DESCRIPTION OF THE PREFERRED EMBODIMENTS

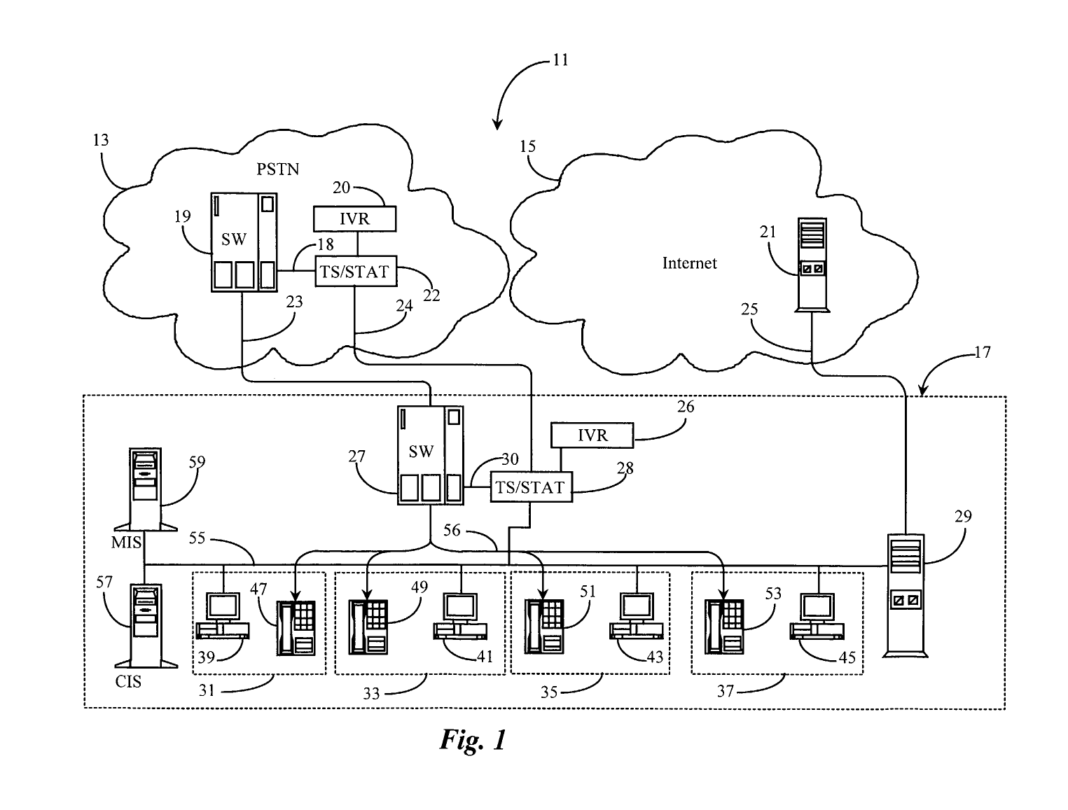

FIG. 1 is a system diagram of a telecommunication network and multimedia communication-center according to art known to the inventor, but not necessarily public, as a basis for describing the present invention.

In FIG. 1 telecommunications network 11 comprises a publicly-switched telephone network (PSTN) 13, the Internet network 15, and a multimedia communication-center 17. PSTN network 13 may be a private network rather than a public network, and Internet 15 may be another public or a private data network as are known in the art.

In this example, communication center 17 is equipped to handle both COST calls and IPNT calls which represents state of the art development for such communication centers. Both COST calls and IPNT calls are delivered to communication center 17 by separate network connections. For example, a telephony switch 19 in the PSTN may receive incoming telephone calls and rout them over a COST network connection 23 to a central switching apparatus 27 located within communication center 17. IPNT calls via Internet 15 are routed via a data router 21 over a data-network connection 25 to an IPNT router 29 within communication center 17.

In this example, an enhancement known to the inventor is provided in that network switch 19 is connected via CTI link 18 to a CTI-processor 22 running an instance of a CTI application known to the inventor as a T-server (TS) and an instance of Statistical server (STAT). An intelligent peripheral of the form of an interactive voice recognition unit (IVR) 20 is connected to processor 22 via a data link. Similar equipment is found in multimedia communication-center 17 namely, a processor 28 running instances of T-Server and STAT-server connected to central-switching apparatus 27 and further connected to a LAN 55, and an intelligent peripheral of the form of an IVR 26 which is connected to processor 28 via a data link.

Both of the above described equipment groupings are connected to each other via a separate data network 24. In this way, data about a customer may arrive at communication center 17 ahead of an actual call. This enhancement is known to the inventor and the enabled method is termed “double dipping” by the inventor. It is shown here only for the purpose of illustrating this enhancement as being available in systems as known to the inventor.

Data router 21 in cloud 15 is exemplary of routers, servers, IP switches, and other such dedicated equipment that may be assumed to be present but not specifically illustrated therein. There also may be, in network 15, processors running instances of T-servers and Stat-servers and connected to data routers, such as data router 21, and by data links to processor 28 in our exemplary telecommunication center 17, although not shown.

Call center 17 in this example comprises four agent stations 31, 33, 35, and 37 adapted to engage in multimedia interaction with customers. Each of these agent stations, such as agent station 31, for example, comprises an agent's telephone 47 for COST telephone communication and an agent's PC/VDU 39 for IPNT communication and additional data processing and viewing. Agent's telephones 49, 51, and 53 along with agent's PC/VDU 41, 43, and 45 are in similar arrangement in agent stations 33, 35, and 37 respectively. Agent's telephones, such as agent's telephone 49, are connected to COST switching apparatus 27 via telephone wiring 56.

LAN 55 connects agent's PC/VDU's to one another and to IPNT data-router 29. A client-information-system (CIS) server 57 is connected to LAN 55 and provides additional stored information about callers, usually customers of the center's host, to each LAN-connected agent. Information such as purchase history, credit information, contact information and the like is stored and retrievable. A multimedia server (MIS) 59 is connected to LAN 55 and adapted to store and serve multimedia transactions such as e-mail, video mails, IVR recordings, transferred files, etc.

Router 29 routes incoming IPNT calls to agent's PC/VDU's that are LAN connected as previously described. Data-network connection 25 connects data router 29 to data router 21 located in Internet 15. Specific Internet access and connectivity is not shown, but is well known in the art, and may be accomplished in any one of several ways. Dial-up connection and continuous LAN connection are exemplary methods.

In this example, each agent's PC/VDU, such as PC/VDU 45, has a continuous connection via LAN 55 and data network connection 25 to Internet 15 while the assigned agent is logged on to the system, however, this is not specifically required but rather preferred, so that incoming IPNT calls may be routed efficiently.

In examples provides herein, an object of the description is to show a new and innovative method of routing transaction requests to resources. Agents at agent stations are good examples, but not limiting examples, of resources to which transaction requests, such as incoming calls, may be routed. It will be apparent to the skilled artisan, however, that there may be other resources to which a transaction request may be routed. As an extreme example, the system may decide by the methods of the invention, that in incoming call should go directly to an officer of the company that hosts the call center, who is on vacation, and an outbound call will be made to the officer at an alternate number available. In other instances, there may be facility at the call center to host home agents, and to provide such agents with all of the services of the call center. Although these home agent facilities are not shown in the drawings, the inventor intends that such are to be included in the methods of the invention. The system of the invention routes transaction requests to whatever resources are available and configured into the system.

Returning now to FIG. 1, an agent operating at an agent station such as agent station 33 may have COST calls arriving on agent's telephone 49 while IPNT calls are arriving on agent's PC/VDU 41.

Routing of COST events within center 17 is performed via routines associated with the T-Server running on processor 28. Routing of DNT events including IPNT calls is performed via IPNT router 29. In some embodiments, DNT routing may also be affected via processor 28 by virtue of it's T-Server capability and LAN connection.

It will be apparent to one with skill in the art that various routing protocols may be practiced within this system both at the network level and within center 17, and that predictive routing based on customer history may be practiced with system access of CIS 57 which contains information regarding the customer as previously described. However, current art regimens are somewhat limited in scope regarding updating, reporting, and access of data including cross-referencing, analyzing and so on.

While predictive routing based on history has merits within certain situations, it is desired in many instances to provide a more direct and complete analysis of a potential transaction's fiscal impact on a company whether positive or negative. This is especially true within certain profit-driven organizations as was mentioned in the background section. Therefore, it is an object of the present invention to provide a system of data storage and an intelligent routing routine, not previously available to the public, that can effectively prioritize and route calls based on an analysis of the margin of profit contribution to the company expected from a potential transaction, on a transaction-by-transaction basis.

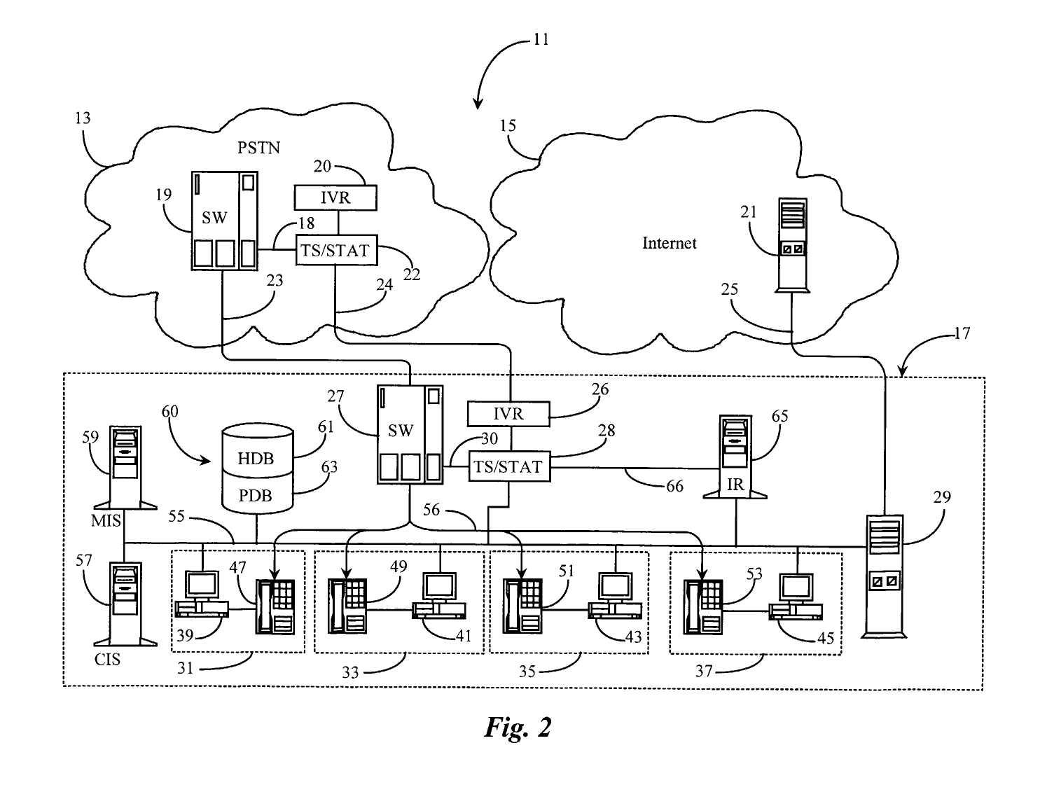

FIG. 2 is a system diagram of the telecommunication network and multimedia communication center of FIG. 1 enhanced with predictive potential-profit-based routing according to an embodiment of the present invention. In an effort to avoid redundancy, elements introduced and described with reference to FIG. 1 that are also present in FIG. 2 are not re-introduced unless they have been altered according to an embodiment of the present invention.

One basic enhancement to communication center 17 as known to the inventor involves connecting agent telephones 47-53 to their associated PC/VDU's 39-45 at agent stations 31-37 respectively, and as illustrated with the addition of connecting lines at each station. This method employs use of I/O cables to facilitate a connection from a telephone transceiver/receiver to the sound card on a computer. In this way a single headset or handset telephone may be used to receive both COST calls from PSTN 13 or IPNT calls from Internet 15. While this architecture is not required to practice the present invention, such connections aid in functional performance and call-monitoring ability within communication center 17 and may, in some instances, aid the function of the present invention.

According to a preferred embodiment of the present invention, a mass-storage repository 60 comprising a historical database (HDB) 61 and a product database (PDB) 63 is provided and connected to LAN 55. HDB 61 contains complete historical records of client status and transaction activity regarding interaction with communication center 17 such as purchase history including dollar amounts for each transaction, type of product or service purchased, date of purchase, quantity parameters, order numbers, etc. The specific character of the stored data may vary widely. It may also reside in other facilities, and be remotely accessed, by a multitenant call-center, having such a DB connection for each of the tenants sharing use of the call center. It is clear that there are many setups and configurations that can be used to achieve the same in this or other environment, but they all essentially allow access to a data base, so for simplicity purposes only one DB is shown.

Status records indicate, among other things, financial status, demographic category, family status including listings of relatives, employment record, net-worth information, and any other parameters that may be legally obtained and documented. Such information is recorded and updated over time during normal transaction occurrences between center 17 and the client. Other facts about clients may be solicited through IVR, questionnaire, purchased information from other sources, and so on.

PDB 63 contains product information such as description, pricing, promotional information, order numbers, etc. PDB 63, in this example, resides at the same location (machine 60) as HDB 61 however, a number of other possibilities exist without departing from the spirit and scope of the present invention. For example, each database may be implemented in separate LAN-connected machines within communication center 17.

In one embodiment, such data resources may be stored outside of communication center 17 such as at a central location connected via private wide area network (WAN) to, and shared by, a plurality of geographically distributed communication-centers. In an alternate embodiment, such resources may be securely hosted in public domain within network 15, which in this example, is the Internet. Data access to repository 60 may be provided via LAN 55, as taught herein, or via a WAN as explained above. There are many variant possibilities.

Information-storage rules dictate how client and product related data are stored and accessed. These rules will vary somewhat depending upon the type of enterprise (company hosting the communication center) and location of repository 60 (centralized and shared on WAN; or local on LAN). For example, clients or customers may be categorized according to demographic rules with their parameters and other known information stored in segmented fashion reflecting a particular demographic segment with higher call priority associated with one or more segments.

Accessing certain customer data from HDB 61 may be generally prohibited except via automated routine during routing of calls. In this way, certain privacy or legal aspects may be protected if applicable. Security methods such as encoding, password protection, encryption, use of firewall, and the like may be used to protect information from unauthorized agents (in case of manual access) and or the general public (if repository 60 is WAN-based). Such data protection methods are well known in the art and available to the inventor.

In a preferred embodiment, access to HDB 61 and PDB 63 occurs during automated routing of incoming calls from clients as part of a definitive and innovative process for determining the priority of, and best fit resource destination for, each incoming call based on a system analysis of real and potential profit contribution available to the company from each individual client transaction, in particular a transaction reasonably predictable from a client transaction request and access to the databases and other information with unique code routines according to embodiments of the present invention.

An intelligent router (IR) 65 is provided for the purpose of routing calls from both the COST network 13 and Internet 15 according to predictive history-based and demographics-based profit rules as briefly described above. IR 65 is connected to LAN 55 and also linked to processor 28 via data link 66. Data link 66 is not specifically required here as both IR 65 and processor 28 are LAN connected. However, performance enhancement is often achieved through direct data-linking techniques as is known in the art.

IR 65, by virtue of the innovative predictive-routing method of the present invention, is adapted to access repository 60, obtain relevant information from HDB 61 and PDB 63 that has been prepared and organized in many instances via data mining, and analyze the information in order to determine a resource destination, and in some cases a priority for each call, and then route the call based upon that determination.

In addition to the ability to search and retrieve relevant data from repository 60, IR 65 may also utilize IVR and CIS information to aid in effecting the goal as taught by the present invention. For example, if a client is new, and no current information is available about him or her in repository 60, then a new history may begin with IVR interaction at first contact such as from IVR 20 and, perhaps, from basic information which may be stored in CIS 57 which may contain, but is not limited to, contact information about potential customers or clients that have not yet patronized the company. Thus, after identifying a client, IVR 20 may obtain initial information from the caller for use in searching CIS 57 for additional information which may then be entered into HDB 61.

In addition to historical data, product data, client status, and the like, there are in some cases real time considerations to be made in determining potential profitability. For example, depending on the nature of the enterprise hosting a call center and the products and/or services offered, the IR may access periodically or continually updated records of information such as lending rates (interest rates), stock quotations, load conditions in a network, and so on, as input in various formulas and algorithms developed for determining potential profit. It should also be clear that cost issues also effect profitability and will be taken into account in many algorithmms for determining potential profitability. The present invention is in the nature of the determination rather than in the specific details of how profitability might be determined. That is, it will be clear to the skilled artisan that there are a wide variety of specific algorithms that might be developed within the spirit and scope of the present invention in order to determine potential profitability, depending on such issues as the nature of products and services, the nature of the enterprise, and many other factors.

Once a call is received at central switch 27, IVR 26 may solicit further, more detailed information from the caller, perhaps taking financial information, product interests, or other qualifying demographic information which may be entered into HDB 61. IR 65 may route the call to an agent if enough data can be compiled to formulate a profit-contribution prediction.

If not enough information is known about a client, IR 65 may route the caller to an automated attendant such as an automated fax or alternative IVR attendant. Perhaps a lower priority routing to an information agent may be the determination. Any interaction results are subsequently added to HDB 61 as part of the contact history of that client. In any event, a complete transaction history including any agent/client interaction result is developed, stored and maintained in HDB 61 as the client continues to do business with the company. Interactions, as defined herein, include all multimedia transactions in addition to COST and IPNT calls that may be supported by the system including but not limited to e-mail, video mail, faxes, voice mail, WEB-initiated transaction requests, and so on.

In one embodiment, client data stored in HDB 61 is cross-referenced to product information stored in PDB 63 in order to, for example, match a relevant product promotion to a client based on purchase history. Upon selecting the correct product promotion, product scripting may be provided to an agent ahead of or with the call for use in guiding the client toward placing an order.

It will be apparent to one with skill in the art that as a client develops an interaction history with the company, an average profit contribution from the client to the company per transaction may be easily calculated on an ongoing basis from known cost values such as cost of agent time, service costs, product material costs, and so on. The results of such calculation may, of course, change over time as new variables are added and old variables are discarded. For example, a new income bracket for a client may be a new variable where as the old income information would be purged from HDB 61, and so on. Other methods may also be used rather than just average. For example based on the last transaction being ATM card “eaten” by ATM machine, it is quite reasonable to assume the following transaction is a complaint about that rather than new business, and hence the call may be bumped off to an IVR or a low priority queue. So from this example, it is clear that event sequences can be used to determine the “net value” of the next transaction. Other factors could be time of day (at customer and/or business location, his current location vs. his “normal location”, time of month, time of year, whether at his present location etc.

It will also be apparent to one with skill in the art that the software containing the routine of the present invention may reside in processor 28, IR 65, repository 60, or a combination thereof. Instances of such a routine may also reside at individual agent PC/VDU's such as PC/VDU 39.

It will likewise be apparent to one with skill in the art that underlying rules for determining real and potential profit contribution from a client may vary considerably with call priority determination based on a relatively few or a large number of stored variables. A more detailed example of possible steps performed by the software of the present invention in determining profit contribution and best-fit destination is provided below.

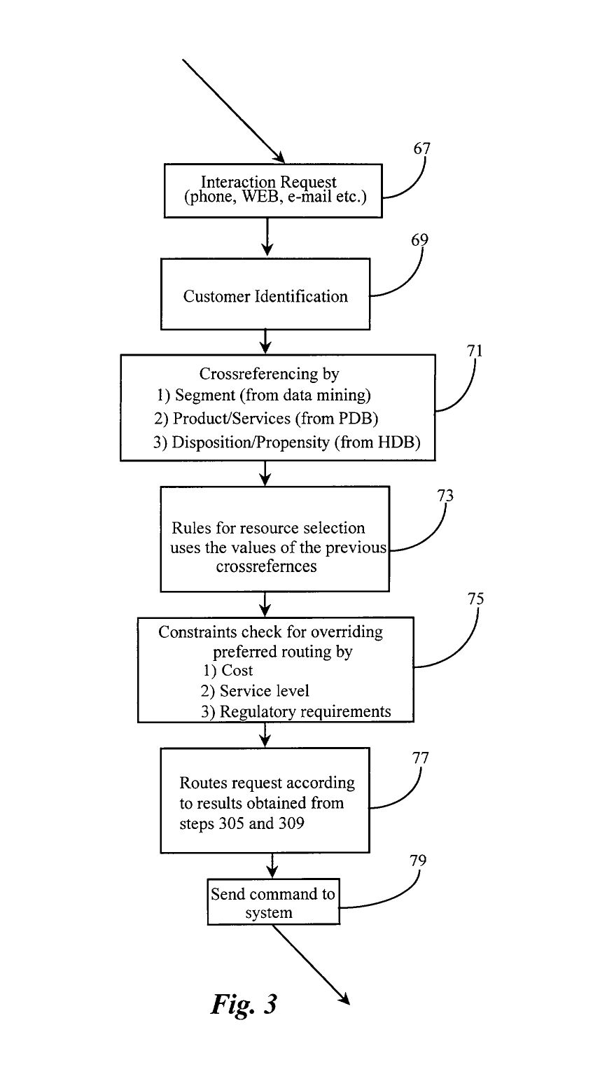

FIG. 3 is a process flowchart illustrating various process steps according to an embodiment of the present invention. The basic steps in determining potential profit contribution, assigning priority and routing an incoming transaction request according to an embodiment of the present invention may vary considerably depending on, among other factors, type of enterprise, products or services offered, number of variables considered, and so on. FIG. 3 is intended to reflect just one example of a possible process sequence.

In step 67, an interaction request is registered at either switch 27 or IPNT router 29 of FIG. 2. An interaction request is defined as being of the form of any supported media such as e-mail, COST call, IPNT call, WEB request, video mail, etc. In step 69, the customer is identified through any one or by a combination of known methods such as caller line identity, domain-name ID, return e-mail address, IP address, and so on. In step 71, data regarding the customer is accessed from HDB 61. IVR 26 and CIS 57 may also contribute to the data pool.

Certain variables such as demographic category, from such info as last credit report, average profit contribution and so on is performed along with cross-referencing to PDB 63 for appropriate product/service information including information on current product promotions, quantity discounts, current interest structure for finance, and so on. Customer disposition at last contact along with propensity toward a purchase decision as averaged over past transaction history may also be obtained from HDB 61.

The retrieved data and cross referencing performed in step 71 will produce the integral variables usable by the routing routine to determine a priority and a resource destination for the transaction request in terms of probable profit contribution, and to make an appropriate resource selection in step 73. A bottom-line predicted profit contribution for the existing transaction is calculated from analyzing of the data. In step 74, a constraint check is performed to validate the interaction and associated data against any preset override conditions set up by the enterprise, such as legal requirements, service level, or cost restraints as well as customer rating which may alter or override prior routing strategy.

In step 77, the routing routine routes the interaction request according to results obtained in steps 71. 73, and 75. If it was calculated that a high profit contribution is probable, then priority for the interaction is high and the interaction is handled accordingly. If however, it is determined that the probable profit contribution is low, non-existent, or even a drain on the company, a lower priority disposition of the caller is warranted. In step 79, the actual command to route the interaction to a selected destination is given to the appropriate delivery system apparatus such as IPNT router 29, switch 27, MIS 59, etc.

In one embodiment wherein a repository such as repository 60 is shared by a plurality of communication centers, existing routines using the same information may vary in process and priority determination methods according to local rules set up at each separate communication center.

Regular updating to repository 60 may be performed via a variety of ways without departing from the spirit and scope of the present invention. For example, manual updating may be part of the duties of a system administrator. Results from mailed questionnaires, automated customer surveys, communication center transactions, purchased information from other sources, credit reporting agencies, demographic studies, and so on, may be entered to and made part of HDB 61. Continual updating and purging of non-valid information is pertinent to maintaining system integrity.

There are many possible embodiments to which the method and apparatus of the present invention may be practiced several of which have already been taught. The spirit and scope of the present invention is limited only by the claims that follow.

What is claimed is:

1. A method for routing transactions in a hosted communication network, comprising steps of;
(a) preparing a customer data repository including specific customer data and customer transaction history;
(b) receiving a new transaction request;
(c) identifying the initiator of the transaction request;
(d) consulting the customer data repository and determining potential profitability of a new transaction based on the transaction request according to the repository information; and
(e) routing the transaction request to an available resource based on the identified potential profitability.

2. The method of claim 1 wherein the hosted communication network is a telecommunication call center.

3. The method of claim 1 wherein, in step (a) past customers are assigned a category based at least in part on demographics, in step (d) customer category is retrieved, and in step (e) routing decision is based at least in part on customer category.

4. The method of claim 1 wherein the data repository tracks customer transaction history at least in part on product choices, the method further comprising a step for matching a customer's product choices with active product promotions from a product database, and using the result as at least a partial basis for routing in step (e).

5. The method of claim 4 wherein, after routing, the product information is used in selecting scripting for directing an agent in interaction with the customer.

6. The method of claim 1 further comprising a step for a constraints check after determining potential profitability in step (d), and overriding routing if suggested by the constraints check.

7. The method of claim 6 wherein the constraints check includes one or more of cost, service level, or regulatory requirements.

8. The method of claim 1 wherein, in step (d) the customer identified is not found in the data repository, further comprising a step for routing the transaction request to a resource adapted to solicit information from the customer for adding the customer to the data repository.

9. An intelligent router in a telecommunications network for determining routing to available resources of an incoming transaction request from a customer, comprising:
an identifier adapted to determine the identity of the customer;
a data collector for consulting a data repository including customer transaction histories and retrieving information about the identified customer;
a determinator for assessing potential profitability of a transaction based on the transaction request; and
a routing selector for selecting a resource for routing the transaction request based on the assessed potential profitability.

10. The intelligent router of claim 9 wherein the data repository includes a category for the identified customer based at least in part on demographics, and the category is used as at least a partial criteria in routing.

11. The intelligent router of claim 9 wherein the data repository tracks customer transaction history based at least in part on product choices, the determinator matches a customer's recorded product choices with active product promotions from a product database, and the routing selector uses the result as at least a partial basis for routing.

12. The intelligent router of claim 9 wherein, after routing, the product information is used in selecting scripting for directing an agent in interaction with the customer.

13. The intelligent router of claim 9 wherein the router makes a constraints check after determining potential profitability in step, and overrides routing if suggested by the constraints check.

14. The intelligent router of claim 13 wherein the constraints check includes one or more of cost, service level, or regulatory requirements.

15. The intelligent router of claim 9 wherein, if the customer identified is not found in the data repository, the transaction request is routed to a resource adapted to solicit information from the customer for adding the customer to the data repository.

16. A multimedia transaction center, comprising:
switching and routing apparatus for receiving and distributing transaction requests to available resources;
a data repository storing customer data including at least demographics and transaction history; and
an intelligent router for determining best routing for incoming transaction requests;
wherein the intelligent router identifies initiators of incoming transaction requests, consults the data repository, determines potential profitability of transactions based on the transaction requests, and routes the transaction requests to available resources based on the determination of potential profitability.

17. The multimedia transaction center of claim 16 wherein, in the data repository customers are assigned a category based at least in part on demographics, and the intelligent router uses the category at least in part for determining routing of the incoming transaction requests.

18. The multimedia transaction center of claim 16 wherein the data repository tracks customer transaction history at least in part on product choices, and the intelligent router uses the history of product choices at least a partial basis for routing.

19. The multimedia transaction center of claim 18 wherein, after routing, the product information is used in selecting scripting for directing an agent in interaction with the customer.

20. The multimedia transaction center of claim 16 wherein the intelligent router makes a constraints check after determining potential profitability, and overrides routing if suggested by the constraints check.

21. The multimedia transaction center of claim 20 wherein the constraints check includes one or more of cost, service level, or regulatory requirements.

22. The multimedia transaction center of claim 16 wherein, if the customer identified is not found in the data repository, the transaction request is routed to a resource adapted to solicit information from the customer for adding the customer to the data repository.
